(19) United States
(12) Patent Application Publication
(10) Pub. No.: US 2025/0108791 A1
(43) Pub. Date: Apr. 3, 2025

(54) DRIVING ASSISTANCE DEVICE, DRIVING ASSISTANCE METHOD, AND STORAGE MEDIUM

(71) Applicant: HONDA MOTOR CO., LTD., Tokyo (JP)

(72) Inventor: Taku YAMAZAKI, Tokyo (JP)

(21) Appl. No.: 18/891,877

(22) Filed: Sep. 20, 2024

(30) Foreign Application Priority Data
Sep. 29, 2023 (JP) 2023-170824
Feb. 21, 2024 (JP) 2024-024771

(51) Int. Cl. B60W 30/09; B60W 30/095; B60W 30/18; B60W 50/00; H04W 4/46

(52) U.S. Cl. CPC B60W 30/09; B60W 30/0956; B60W 30/18159; B60W 50/0097; H04W 4/46; B60W 2554/4041; B60W 2554/4042; B60W 2554/80; B60W 2556/65

(57) ABSTRACT

A driving assistance device performs an intersection identification operation of identifying an intersection between traveling tracks of a self-vehicle and a peripheral vehicle and updates risk position information based on the intersection identified by the intersection identification operation. The device performs the intersection identification operation using, as a first reference position, a position where the self-vehicle accelerates after decelerating to a threshold value or less or a position where the self-vehicle temporarily stops in a case where the peripheral vehicle exists within a first range in front of the self-vehicle and performs the intersection identification operation using, as a second reference position, an intersection between a predicted course of the self-vehicle and a predicted course of the peripheral vehicle in a case where the peripheral vehicle exists within a second range on a side of the self-vehicle.

### CROSS-REFERENCE TO RELATED APPLICATION(S)

This application claims priority to and the benefit of Japanese Patent Application No. 2023-170824, filed Sep. 29, 2023, and Japanese Patent Application No. 2024-024771, filed Feb. 21, 2024, the entire disclosures of which are incorporated herein by reference.

### BACKGROUND OF THE INVENTION

### Field of the Invention

The present invention relates to a driving assistance device, a driving assistance method, and a storage medium.

### Description of the Related Art

In recent years, efforts to provide access to sustainable transportation systems in consideration of vulnerable people among traffic participants have been gaining momentum. In order to realize this, research and development for further improving traffic safety and convenience is focused on research and development related to preventive safety technique. Known is a device that performs driving assistance for preventing a collision with another vehicle (peripheral vehicle) or the like without using map information. Japanese Patent No. 7054636 discloses a driving assistance device that registers, in a storage unit, position information of an intersection where a traveling track of a self-vehicle and a traveling track of another vehicle intersect, and performs driving assistance of the self-vehicle when the self-vehicle passes through the intersection again. Japanese Patent Laid-Open No. 2019-105684 discloses a technique of generating intersection feature data indicating a feature of an intersection by using traveling track data outside the intersection. The driving assistance device can identify a risk position where a self-vehicle may collide with another vehicle on the basis of a traveling track of the self-vehicle and a traveling track of the other vehicle, and can use the risk position for driving assistance. However, in the preventive safety technology, if a risk position is excessively identified for a point where the necessity of driving assistance is relatively low, a risk position is not identified for a point where the necessity of driving assistance is relatively high, or the like, and the intersection position is not appropriately identified, it may be difficult to appropriately perform driving assistance.

### SUMMARY OF THE INVENTION

According to some aspects of the present disclosure, an advantageous technique for appropriately performing driving assistance of a self-vehicle is provided. In addition, accordingly, the present invention contributes to development of a sustainable transportation system.

According to some embodiments, a driving assistance device comprising: a storage unit configured to store risk position information indicating a position where there is a possibility that a self-vehicle mounted with the driving assistance device collides with another vehicle; an assistance unit configured to perform driving assistance for the self-vehicle based on the risk position information; an acquisition unit configured to acquire, from a peripheral vehicle existing around the self-vehicle, peripheral vehicle information indicating a vehicle speed, a position, and a traveling track of the peripheral vehicle by vehicle-to-vehicle communication; an identification unit configured to perform an intersection identification operation of identifying an intersection between a traveling track of the self-vehicle and a traveling track of the peripheral vehicle; and an update unit configured to update the risk position information based on the intersection identified by the intersection identification operation, wherein the identification unit: performs the intersection identification operation using, as a first reference position, a position where the self-vehicle accelerates after decelerating to a threshold value or less or a position where the self-vehicle temporarily stops in a case where the peripheral vehicle exists within a first range in front of the self-vehicle; and performs the intersection identification operation using, as a second reference position, an intersection between a predicted course of the self-vehicle and a predicted course of the peripheral vehicle in a case where the peripheral vehicle exists within a second range on a side of the self-vehicle is provided.

### BRIEF DESCRIPTION OF THE DRAWINGS

FIG. 1 is a block diagram for describing a configuration example of a vehicle according to some embodiments;

FIG. 2 is a flowchart for describing an example of a risk position according to some embodiments;

FIGS. 3A and 3B are schematic diagrams for describing an example of a track intersection according to some embodiments;

FIG. 4 is a schematic diagram for describing an example of driving assistance method according to some embodiment;

FIGS. 5A and 5B are schematic diagrams for describing the presence or absence of a risk position in a target area according to some embodiments;

FIG. 6 is a flowchart for describing an example of a method of registering a peripheral vehicle according to some embodiments;

FIG. 7 is a schematic diagram for describing an example of a range of detection of a peripheral vehicle according to some embodiments;

FIG. 8 is a flowchart for describing an example of an intersection identification operation related to a peripheral vehicle located in front according to some embodiments;

FIGS. 9A and 9B are schematic diagrams for describing an example of an intersection identification operation related to a peripheral vehicle located in front according to some embodiments;

FIG. 10 is a flowchart for describing an example of an intersection identification operation related to a peripheral vehicle located on the side according to some embodiments;

FIGS. 11A and 11B are schematic diagrams for describing an example of an intersection identification operation related to a peripheral vehicle located on the side according to some embodiments; and

FIG. 12 is a schematic diagram for describing an example of a method of determining a peripheral vehicle to be determined according to some embodiments.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Vehicle Configuration Example

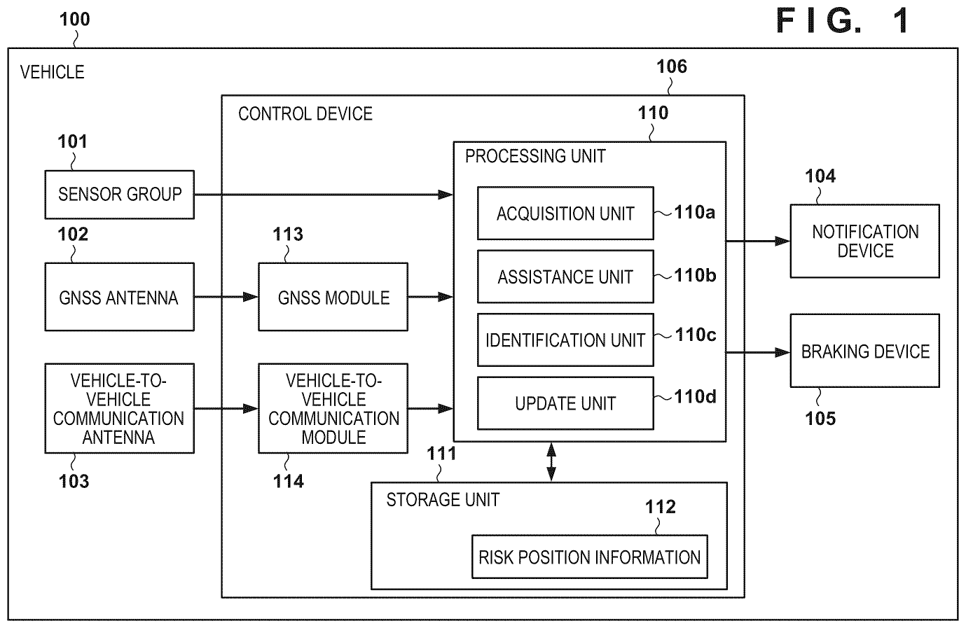

A configuration example of a vehicle 100 according to some embodiments will be described with reference to FIG. 1. As illustrated in FIG. 1, the vehicle 100 may include a sensor group 101, a global navigation satellite system (GNSS) antenna 102, a vehicle-to-vehicle communication antenna 103, a notification device 104, a braking device 105, and a control device 106. Although FIG. 1 illustrates components referenced in the following description, the vehicle 100 may include other components for operating as a vehicle, such as a driving device, a transmission, and a lighting device. Additionally or alternatively, the vehicle 100 may not include some of the components illustrated in FIG. 1. The vehicle 100 may be a four-wheeled vehicle, a two-wheeled vehicle, or another type of vehicle.

The control device 106 controls the overall operation of the vehicle 100. As described later, the control device 106 performs driving assistance of the vehicle 100 on which the control device 106 is mounted. Therefore, the control device 106 may be referred to as a driving assistance device. The driving assistance provided by the control device 106 may be collision prevention assistance for preventing (reducing) a collision with another vehicle. In some embodiments, the control device 106 is capable of performing the collision prevention assistance without using map information. In the following description, the vehicle 100 may be referred to as a self-vehicle 100 to facilitate distinction from other vehicles. In addition, a vehicle different from the vehicle 100 may be referred to as another vehicle. Among other vehicles, a vehicle that currently exists around the self-vehicle 100 may be referred to as a peripheral vehicle. The peripheral vehicle may be a vehicle that can currently perform vehicle-to-vehicle communication with the self-vehicle 100.

The sensor group 101 includes various sensors for performing the driving assistance of the vehicle 100. For example, the sensor group 101 can include a speed sensor that detects the speed of the vehicle 100, an acceleration sensor that detects the acceleration of the vehicle 100, and the like. In addition, the sensor group 101 may include an outside detection sensor such as a camera capable of detecting an object around the vehicle 100, a millimeter wave radar, or a light detection and ranging (LIDAR). The sensor group 101 outputs the detection result to the control device 106.

The GNSS antenna 102 receives radio waves for position measurement transmitted from a GNSS satellite. For example, the GNSS antenna 102 can be used to acquire information regarding the current position and/or the traveling track (traveling history) of the vehicle 100. In addition, the vehicle-to-vehicle communication antenna 103 is an antenna that transmits and receives various data to and from a peripheral vehicle. For example, the vehicle-to-vehicle communication antenna 103 can be used to acquire information regarding the current position, speed, and traveling track of a peripheral vehicle.

The notification device 104 is a device that notifies an occupant (for example, a driver) of the vehicle 100. In a case where the vehicle 100 may collide with a peripheral vehicle, the control device 106 can notify the occupant of the vehicle 100 of the collision possibility with the peripheral vehicle by the notification device 104 as driving assistance. For example, the notification device 104 may include a display unit such as a display and display information indicating a collision possibility with a peripheral vehicle on the display unit, or may include a sound output unit such as a speaker and output information indicating a collision possibility with a peripheral vehicle from the sound output unit by sound or the like.

The braking device 105 is a device, such as a brake, for performing a braking operation of the vehicle 100. In a case where the vehicle 100 may collide with a peripheral vehicle, as driving assistance, the control device 106 can perform deceleration assistance of the vehicle 100 by operating the braking device 105, enabling prevention of collision with the peripheral vehicle.

The control device 106 is a device (computer) that controls the vehicle 100, and can include, for example, an electric control unit (ECU). The control device 106 can perform driving assistance through vehicle-to-vehicle communication with another vehicle and processing in the vehicle 100. For example, the control device 106 can perform driving assistance without using map information. The control device 106 includes a processing unit 110, a storage unit 111, a GNSS module 113, and a vehicle-to-vehicle communication module 114, that are connected by a bus (not illustrated).

The processing unit 110 is a processor represented by a central processing unit (CPU), and executes a program stored in the storage unit 111. The storage unit 111 includes, for example, a random access memory (RAM), a read only memory (ROM), a hard disk, and the like, and stores a program (driving assistance program) for the processing unit 110 to perform driving assistance processing of the vehicle 100, a program (learning program) for the processing unit 110 to learn a risk position, various data, and the like. The storage unit 111 may store risk position information 112 created on the basis of an intersection of a traveling track of the vehicle 100 and a traveling track of another vehicle. The risk position information 112 may include a plurality of risk positions. The risk position may be a position where the vehicle 100 may collide with another vehicle or a position where the collision possibility is high. The risk position information 112 may be managed as a database.

The GNSS module 113 receives position information and the like of the vehicle 100 from the GNSS satellite via the GNSS antenna 102. In addition, the vehicle-to-vehicle communication module 114 receives various types of information from another vehicle via the vehicle-to-vehicle communication antenna 103.

The processing unit 110 can include an acquisition unit 110a, an assistance unit 110b, an identification unit 110c, and an update unit 110d to perform driving assistance (collision prevention assistance in some embodiments) for the vehicle 100. Note that, the processing unit 110 is not limited to the configuration including the units 110a to 110d. Another unit may be added or some units may be omitted depending on the type of driving assistance performed by the vehicle 100.

The acquisition unit 110a acquires peripheral vehicle information indicating a current position, a vehicle speed, and a traveling track of a peripheral vehicle that exists around the vehicle 100 from the peripheral vehicle via the vehicle-to-vehicle communication antenna 103 (vehicle-to-vehicle communication module 114). The peripheral vehicle information may explicitly or implicitly represent the current position, the vehicle speed, and the traveling track of the peripheral vehicle. For example, the peripheral vehicle information may include the vehicle speed as it is, or may include information for calculating the vehicle speed (two current and previous geographical positions and their positioning times). The acquisition unit 110a may acquire self-vehicle information indicating a current position, a speed, and a traveling track of the vehicle 100 via the sensor group 101 and the GNSS antenna 102 (GNSS module 113).

The assistance unit 110b predicts a possibility that the vehicle 100 collides with another vehicle in a target area in front of the vehicle 100 on the basis of self-vehicle information and peripheral vehicle information acquired by the acquisition unit 110a, and controls driving assistance (collision prevention assistance) for the vehicle 100 on the basis of the prediction result. The target area may be understood as an area (driving assistance area) to be subjected to driving assistance for preventing a collision between the vehicle 100 and another vehicle, and may be simply referred to as a “target area” hereinafter. In some embodiments, the assistance unit 110b can perform, as driving assistance for the vehicle 100, at least one of notification to an occupant of the vehicle 100 by the notification device 104 and deceleration assistance of the vehicle 100 by the braking device 105.

In addition, the assistance unit 110b may perform driving assistance for the vehicle 100 on the basis of the risk position information 112. For example, the assistance unit 110b may change the degree of driving assistance (collision prevention assistance) for the vehicle 100 in accordance with whether or not at least one risk position among a plurality of risk positions included in the risk position information 112 exists in the target area.

For example, in a case where at least one risk position exists in the target area, the assistance unit 110b increases the degree of driving assistance for the vehicle 100 as compared with the case where no risk position exists in the target area. Examples of increasing the degree of driving assistance for the vehicle 100 include relaxing the operation condition of the driving assistance so that the driving assistance is likely to operate, increasing the notification level in the notification device 104, increasing the deceleration of the vehicle 100 by the braking device 105, and the like. The operation condition of the driving assistance can be relaxed by increasing a time threshold value for activating the driving assistance with respect to a time to collision (TTC) calculated as a collision possibility of the vehicle 100.

The identification unit 110c identifies an intersection between a traveling track of the vehicle 100 and a traveling track of a peripheral vehicle. The operation of identifying the intersection between the traveling track of the vehicle 100 and the traveling track of the peripheral vehicle is hereinafter referred to as an intersection identification operation. The intersection between the traveling track of the vehicle 100 and the traveling track of the peripheral vehicle is hereinafter referred to as a track intersection. There may be a road intersection near the track intersection. The conditions for starting the intersection identification operation and the details of the intersection identification operation will be described later.

The update unit 110d updates the risk position information 112 stored in the storage unit 111 on the basis of the track intersection identified by the intersection identification operation. For example, the update unit 110d may update the risk position information 112 by adding the track intersection to the risk position information 112. Alternatively or additionally, the update unit 110d may update the risk position information 112 by correcting any risk position included in the risk position information 112 on the basis of the track intersection.

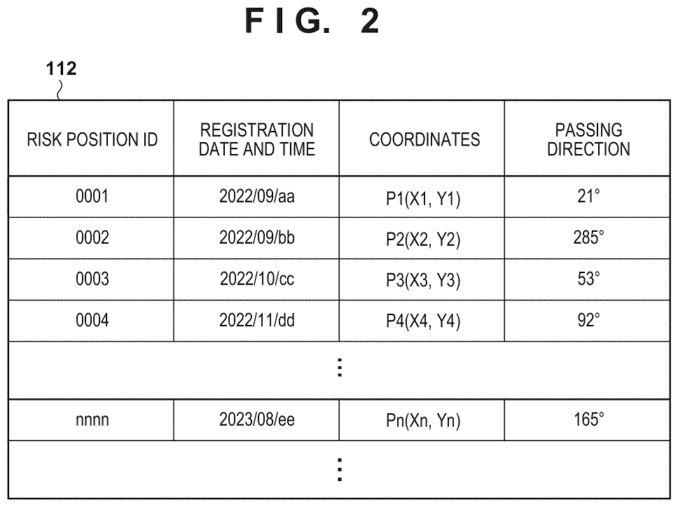

Subsequently, an example of the risk position information 112 will be described with reference to FIG. 2. In the example of FIG. 2, the risk position information 112 is described in a table format, but the risk position information 112 may be in another format. The risk position information 112 has a record for each risk position. The column of the risk position information 112 illustrated in FIG. 2 is an example. The risk position information 112 may include other columns or may not include a part of the columns illustrated in FIG. 2.

The risk position information 112 may include information regarding a risk position ID, registration date and time, coordinates, and a passing direction for each risk position. The risk position ID is a number for uniquely identifying the risk position. The registration date and time is a date and time when the risk position is registered in the risk position information 112. The coordinates are data for identifying the risk position, and are represented by, for example, latitude and longitude data. In addition to the latitude and longitude data, the coordinates may include altitude data such as elevation. The passing direction is a direction (direction, angle) in which the vehicle 100 faces when passing through the track intersection used to determine the risk position. The passing direction may be understood as a traveling direction (entering direction) of the vehicle 100 when entering the track intersection. In the example of FIG. 2, the passing direction of the vehicle 100 is prescribed with the north direction as 0°, the east direction as 90°, the south direction as 180°, and the west direction as 270°.

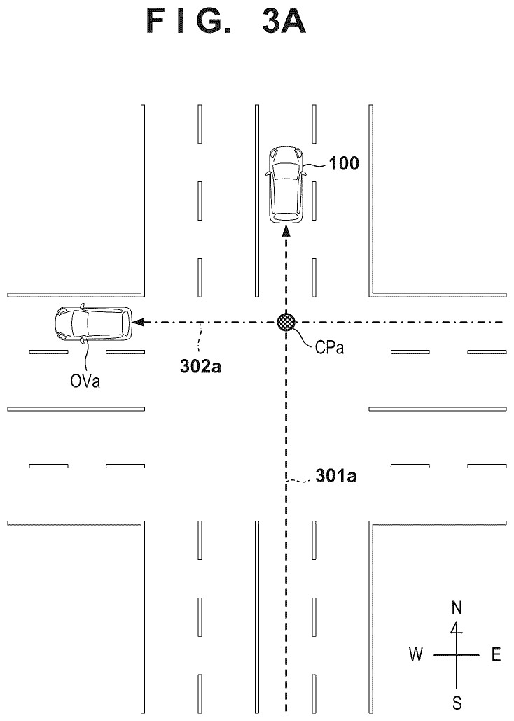

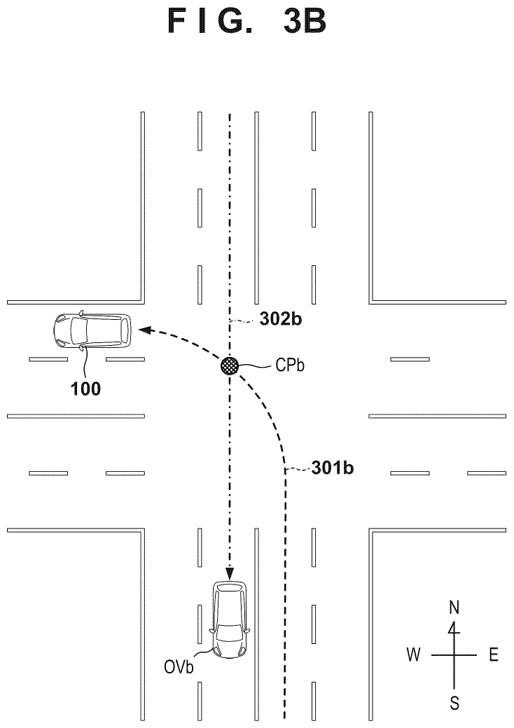

Subsequently, an example of the track intersection will be described with reference to FIGS. 3A and 3B. As described above, the track intersection is an intersection between a traveling track of the vehicle 100 and a traveling track of another vehicle. In the present specification, a case will be described in which the vehicle 100 is traveling in an area where right-hand traffic is mandatory. In this case, an opposite lane side of the vehicle 100 means the left side of the vehicle 100. The embodiment described in the present specification is also applicable to a case in which the vehicle 100 is traveling in an area where left-hand traffic is mandatory. In this case, the opposite lane side of the vehicle 100 means the right side of the vehicle 100.

In the example illustrated in FIG. 3A, a position where a traveling track 301a of the self-vehicle 100 traveling straight in the north direction and a traveling track 302a of another vehicle OVa traveling straight in the west direction intersect is a track intersection CPa. Since the timing (time) at which the self-vehicle 100 passes through the track intersection CPa and the timing (time) at which the other vehicle OVa passes through the track intersection CPa are different from each other, no collision occurs between the self-vehicle 100 and the other vehicle OVa. In addition, the traveling track 301a of the self-vehicle 100 is included in the self-vehicle information acquired by the acquisition unit 110a via the sensor group 101 and the GNSS antenna 102 (GNSS module 113). The traveling track 302a of the other vehicle OVa is included in other vehicle information acquired by the acquisition unit 110a via the vehicle-to-vehicle communication antenna 103 (vehicle-to-vehicle communication module 114). Since the other vehicle OVa at the time of the acquisition is a peripheral vehicle that exists around the self-vehicle 100, the other vehicle information may be understood as peripheral vehicle information.

In the example illustrated in FIG. 3B, a position where a traveling track 301b of the self-vehicle 100 traveling straight in the north direction and turning left, and a traveling track 302b of another vehicle OVb traveling straight in the south direction intersect is a track intersection CPb. Note that, since the timing (time) at which the self-vehicle 100 passes through the track intersection CPb and the timing (time) at which the other vehicle OVb passes through the track intersection CPb are different from each other, no collision occurs between the self-vehicle 100 and the other vehicle OVb. In addition, similarly to the traveling track 301a, the traveling track 301b of the self-vehicle 100 is included in the self-vehicle information acquired by the acquisition unit 110a via the sensor group 101 and the GNSS antenna 102 (GNSS module 113). Similarly to the traveling track 302a, the traveling track 302b of the other vehicle OVb is included in the other vehicle information (peripheral vehicle information) acquired by the acquisition unit 110a via the vehicle-to-vehicle communication antenna 103 (vehicle-to-vehicle communication module 114).

The function of the control device 106 can be realized by either hardware or software. For example, the function of the control device 106 may be realized by the processing unit 110 (CPU) performing the driving assistance program and/or the learning program as described above, or may be realized by an integrated circuit such as a programmable logic device (PLD) or an application specific integrated circuit (ASIC). In addition, in the example of FIG. 1, although the control device 106 is illustrated as a single element, the control device 106 may be divided into two or more elements as necessary.

### Driving Assistance Processing

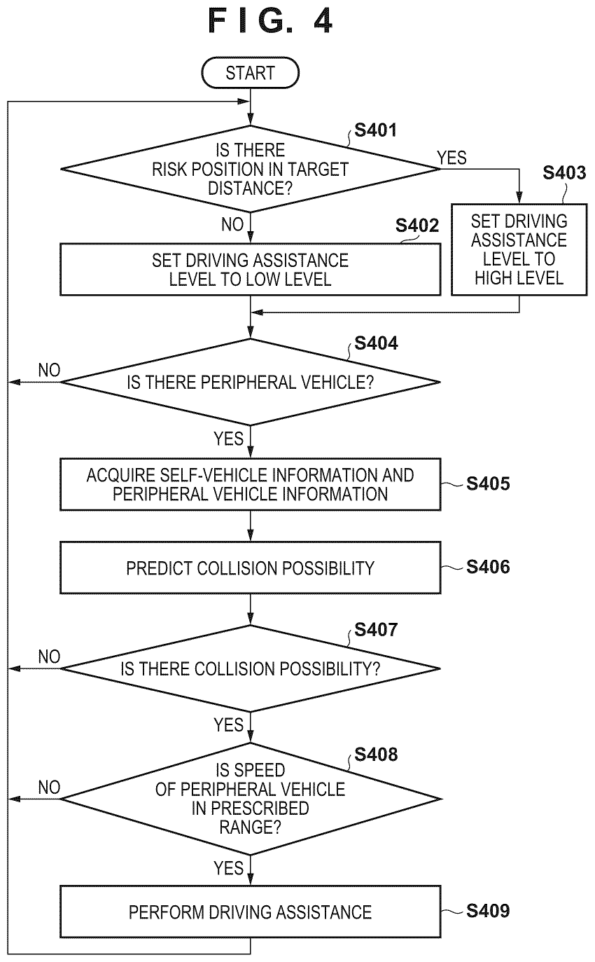

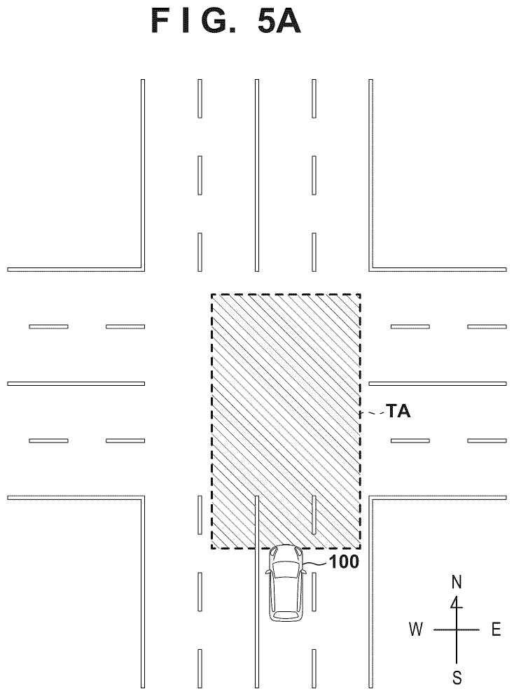

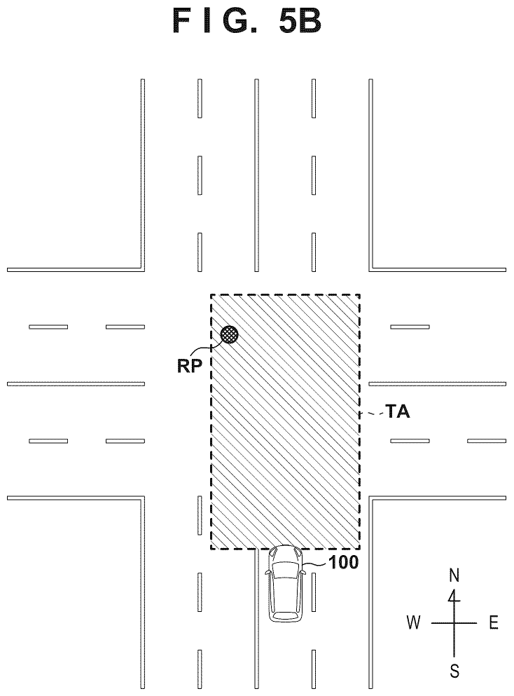

Driving assistance processing of some embodiments will be described with reference to FIGS. 4 to 5B. The driving assistance processing illustrated in the flowchart of FIG. 4 may be performed by the processing unit 110 performing a driving assistance program read from the storage unit 111 in the control device 106. The processing in FIG. 4 may be started, for example, in response to the setting of the driving assistance being turned on. The processing in FIG. 4 may be repeatedly performed until the setting of the driving assistance is turned off or the ignition of the vehicle 100 is turned off.

In step S401, the processing unit 110 (for example, the assistance unit 110b thereof) refers to the risk position information 112 stored in the storage unit 111 to determine whether or not a risk position RP exists in a target area TA in front of the vehicle 100. For example, the processing unit 110 can determine whether or not the risk position RP exists in the target area TA by comparing the current position of the vehicle 100 acquired by the acquisition unit 110a via the GNSS antenna 102 (GNSS module 113) with the coordinates (latitude, longitude) of each risk position RP included in the risk position information 112. FIG. 5A illustrates an example in which the risk position RP does not exist in the target area TA in front of the vehicle 100, and FIG. 5B illustrates an example in which the risk position RP exists in the target area TA in front of the vehicle 100.

In a case where the risk position RP does not exist in the target area TA, the processing unit 110 shifts the processing to step S402. The processing unit 110 (for example, the assistance unit 110b thereof) sets the driving assistance level as the degree of driving assistance to a low level. On the other hand, in a case where the risk position RP exists in the target area TA, the processing unit 110 shifts the processing to step S403. The processing unit 110 (for example, the assistance unit 110b thereof) sets the driving assistance level to a high level. The high level is set such that the degree of driving assistance (driving assistance level) is larger than the low level. For example, in a case where the driving assistance level is at a high level, the operation condition of the driving assistance may be relaxed as compared with the case where the driving assistance level is at a low level. That is, in a case where the driving assistance level is at a high level, driving assistance may be more likely to occur as compared with the case where the driving assistance level is at a low level. For example, even in a situation where the driving assistance is not performed in a case where the driving assistance level is at a low level (for example, the vehicle 100 is in a particular travel state, the vehicle 100 is traveling on a particular road, or the like), the driving assistance may be performed in a case where the driving assistance level is at a high level. Note that, in the present embodiment, two types of driving assistance levels, that is, a low level and a high level are exemplified, but the driving assistance level is not limited to two types and may be three or more types.

In step S404, the processing unit 110 determines whether or not there is a peripheral vehicle RV. As described above, the peripheral vehicle RV is a vehicle that currently exists around the vehicle 100. For example, in a case where vehicle-to-vehicle communication can be performed via the vehicle-to-vehicle communication antenna 103 (vehicle-to-vehicle communication module 114), the processing unit 110 may determine that the peripheral vehicle RV exists. The processing unit 110 shifts the processing to step S401 in a case where it is determined that no peripheral vehicle RV exists, and shifts the processing to step S405 in a case where it is determined that the peripheral vehicle RV exists.

In step S405, the processing unit 110 (acquisition unit 110a) acquires self-vehicle information and peripheral vehicle information. For example, the processing unit 110 acquires, from a peripheral vehicle RV, the peripheral vehicle information including a current position, a speed, and a traveling track of the peripheral vehicle RV via the vehicle-to-vehicle communication antenna 103 (vehicle-to-vehicle communication module 114). In addition, the processing unit 110 acquires the self-vehicle information including a current position, a speed, and a traveling track of the vehicle 100 via the sensor group 101 and the GNSS antenna 102 (GNSS module 113).

In step S406, the processing unit 110 (for example, the assistance unit 110b thereof) predicts a collision possibility between the vehicle 100 and the peripheral vehicle RV in the target area TA on the basis of the self-vehicle information and the peripheral vehicle information acquired in step S405. Thereafter, in step S407, the processing unit 110 (for example, the assistance unit 110b thereof) determines whether or not there is a collision possibility between the vehicle 100 and the peripheral vehicle RV on the basis of the prediction result in step S406. The processing unit 110 shifts the processing to step S401 in a case where it is determined that there is no collision possibility, and shifts the processing to step S408 in a case where it is determined that there is the collision possibility.

In step S408, the processing unit 110 (for example, the assistance unit 110b thereof) determines whether or not the speed of the peripheral vehicle RV is within a prescribed range on the basis of the peripheral vehicle information acquired in step S405. The prescribed range can be set in advance using the speed lower limit value and the speed upper limit value related to the speed of the peripheral vehicle RV. In a case where the speed of the peripheral vehicle RV is equal to or less than the speed lower limit value in the prescribed range, there is a high possibility that a driver of the peripheral vehicle RV notices the vehicle 100 and decelerates the peripheral vehicle RV without colliding with the vehicle 100. That is, the speed lower limit value in the prescribed range related to the speed of the peripheral vehicle RV can be set to a value that allows the peripheral vehicle RV to be decelerated without colliding with the vehicle 100. In addition, in a case where the speed of the peripheral vehicle RV is equal to or greater than the upper limit value of the prescribed range, there is a high possibility that the peripheral vehicle RV is not a vehicle traveling on a road the vehicle 100 enters, such as traveling on an expressway in the vicinity of the road the vehicle 100 enters. That is, the upper limit value of the prescribed range related to the speed of the peripheral vehicle RV can be set to a value that enables determination of whether the vehicle is traveling on a road the vehicle 100 enters or traveling on an expressway in the vicinity of the road. In this manner, the driving assistance is performed/suppressed in accordance with whether or not the speed of the peripheral vehicle RV is within the prescribed range, so that it is possible to reduce annoyance feeling of a driver of the vehicle 100 against the driving assistance.

In a case where it is determined in step S408 that the speed of the peripheral vehicle RV is not within the prescribed range, that is, outside the prescribed range, the processing unit 110 shifts the processing to step S401. That is, in the case of the method of FIG. 4, regardless of the collision possibility predicted in steps S406 to S407, the processing unit 110 does not perform driving assistance for the vehicle 100 in a case where the speed of the peripheral vehicle RV is outside the prescribed range. On the other hand, in a case where it is determined that the speed of the peripheral vehicle RV is within the prescribed range, the processing unit 110 shifts the process to step S409. In step S409, the processing unit 110 (assistance unit 110b) performs driving assistance for the vehicle 100. As driving assistance for the vehicle 100, the processing unit 110 can notify an occupant of the vehicle 100 of the collision possibility by the notification device 104, and perform a braking operation of the vehicle 100 by the braking device 105.

In this manner, the control device 106 changes the degree of driving assistance (driving assistance level) for the vehicle 100 in accordance with whether or not the risk position RP exists in the target area TA in front of the vehicle 100.

### Risk Position Learning Processing

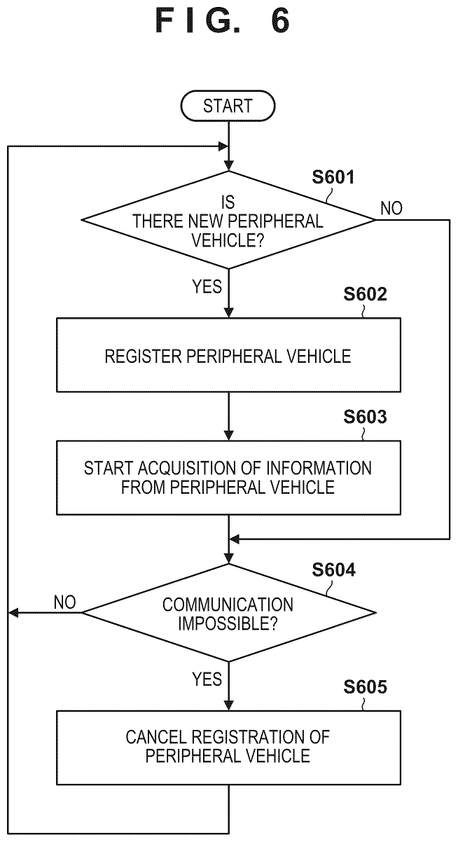

With reference to FIGS. 6 to 11B, risk position learning processing will be described. FIG. 6 illustrates an example of processing of managing a peripheral vehicle. The processing illustrated in the flowchart of FIG. 6 is performed by the processing unit 110 in parallel with the flowchart of FIG. 4 in accordance with the learning program read from the storage unit 111. The processing in FIG. 6 may be started, for example, in response to the ignition of the vehicle 100 being turned on. The processing in FIG. 6 can be repeatedly performed until the ignition of the vehicle 100 is turned off.

In step S601, the processing unit 110 (for example, the acquisition unit 110a thereof) determines whether or not another vehicle exists around the self-vehicle 100. In a case where it is determined that another vehicle exists around the self-vehicle 100, the processing unit 110 shifts the processing to step S602, and shifts the processing to step S604 in other cases. For example, similarly to step S404 in FIG. 4, in a case where vehicle-to-vehicle communication can be performed via the vehicle-to-vehicle communication antenna 103 (vehicle-to-vehicle communication module 114), the processing unit 110 may determine that another vehicle exists around the self-vehicle 100.

In step S602, the processing unit 110 (for example, the acquisition unit 110a thereof) registers another vehicle found in step S601 as a peripheral vehicle. For example, the storage unit 111 may store a list of peripheral vehicles, and the processing unit 110 may add information of the found peripheral vehicle to this list. As will be described later, the peripheral vehicle is used as a target of the intersection identification operation.

In step S603, the processing unit 110 (for example, the acquisition unit 110a thereof) starts acquisition of peripheral vehicle information from the peripheral vehicle by the vehicle-to-vehicle communication. As described above, the peripheral vehicle information may represent the vehicle speed, the position, and the traveling track of the peripheral vehicle. After starting the acquisition of the peripheral vehicle information in step S603, until it becomes impossible to perform the vehicle-to-vehicle communication with the peripheral vehicle, the processing unit 110 periodically (for example, every 100 ms) repeatedly acquires the peripheral vehicle information.

After the start of the acquisition of the peripheral vehicle information, in step S604, the processing unit 110 (for example, the acquisition unit 110a thereof) determines whether or not a vehicle that cannot perform the vehicle-to-vehicle communication exists among one or more registered peripheral vehicles. In a case where such a vehicle exists, the processing unit 110 shifts the processing to step S605, and shifts the processing to step S601 in other cases. For example, in a case where the peripheral vehicle is out of the communication range of the vehicle-to-vehicle communication or the power of the peripheral vehicle is turned off, the vehicle 100 cannot perform the vehicle-to-vehicle communication with the peripheral vehicle.

In step S605, the processing unit 110 (for example, the acquisition unit 110a thereof) cancels the registration of the peripheral vehicle that cannot perform the vehicle-to-vehicle communication. In other words, the processing unit 110 does not treat the vehicle that cannot perform the vehicle-to-vehicle communication as a peripheral vehicle. For example, the processing unit 110 deletes, from the list of peripheral vehicles stored in the storage unit 111, information on the peripheral vehicle that cannot perform the vehicle-to-vehicle communication.

As described above, by performing the processing in FIG. 6, the processing unit 110 can periodically acquire the latest peripheral vehicle information from another vehicle (that is, a peripheral vehicle) located around the self-vehicle 100.

Next, a method of learning the risk position using the peripheral vehicle information acquired in this manner will be described. As described with reference to FIG. 3A, when both the self-vehicle 100 and another vehicle travel straight in a case where the other vehicle is included in the range on the side of the self-vehicle 100, these vehicles may collide with each other. On the other hand, as described with reference to FIG. 3B, when the self-vehicle 100 turns left and another vehicle travels straight in a case where the other vehicle is included in the range in the forward part of the self-vehicle 100, these vehicles may collide with each other. As described above, depending on the position of the other vehicle with respect to the self-vehicle 100, the position (that is, the risk position) where these vehicles may collide with each other can vary. Therefore, in some embodiments, the control device 106 learns the risk position such that the risk position varies according to whether the peripheral vehicle exists within the range in front of the self-vehicle 100 or within the range on the side of the self-vehicle 100.

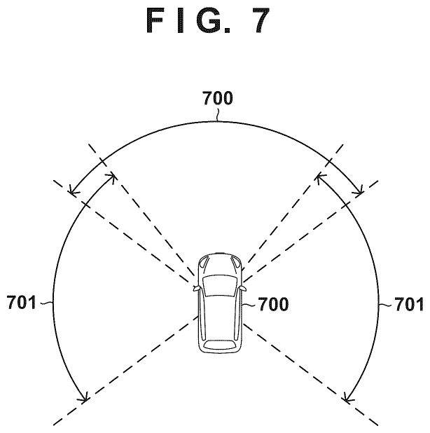

With reference to FIG. 7, a range for selecting the risk position learning method will be described. A range 700 is located at forward part of the vehicle 100. The forward part of the vehicle 100 may be a range including the front of the vehicle 100. As illustrated in FIG. 7, the range 700 may be a fan-shaped region or may have another shape. The range 700 may be symmetrical with respect to the direction of the front of the vehicle 100. The central angle of the range 700 may be, for example, about 100 degrees to 110 degrees A range 701 is located on the side of the vehicle 100. The side of the vehicle 100 may be a range including the oblique front of the vehicle 100. The range 701 may include the direction just beside the vehicle 100. As illustrated in FIG. 7, the range 701 may be a fan-shaped region or may have another shape. In the example of FIG. 7, the range 701 is located on each of the right side and the left side of the vehicle 100. The central angle of the range 701 may be, for example, about 80 degrees to 90 degrees. In the example of FIG. 7, a part of the range 700 and a part of the range 701 overlap. The central angle of the overlapped part may be, for example, about 10 degrees to 20 degrees. In a case where a peripheral vehicle exists in the overlapped part, the peripheral vehicle is subjected to both an intersection identification operation (to be described later) for identifying the track intersection CPa in FIG. 3A and an intersection identification operation (to be described later) for identifying the track intersection CPb in FIG. 3B. Instead of the example of FIG. 7, the range 700 and the range 701 may be only in contact with each other or may be separated from each other.

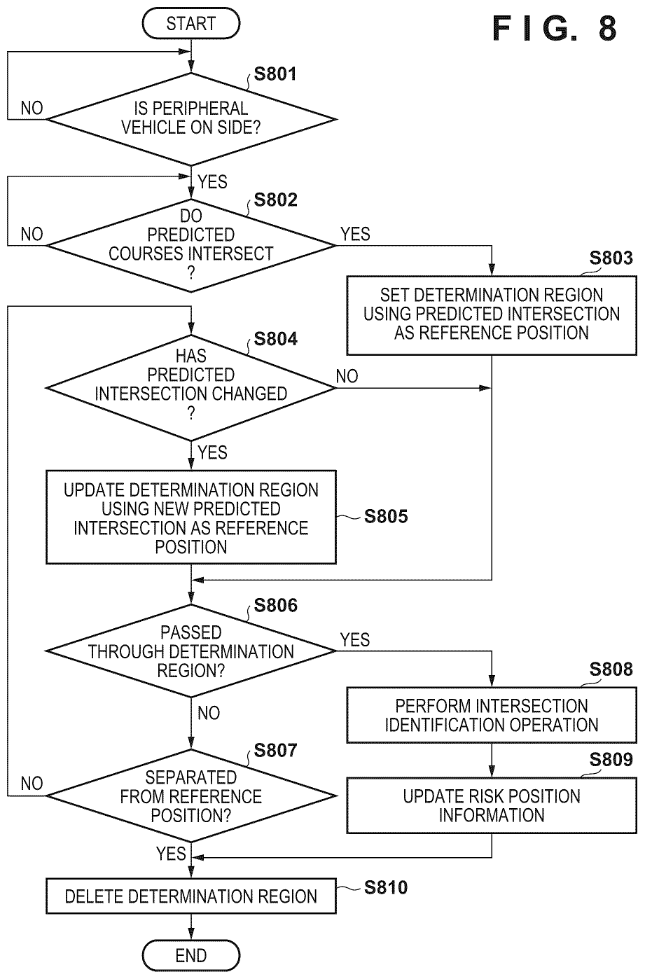

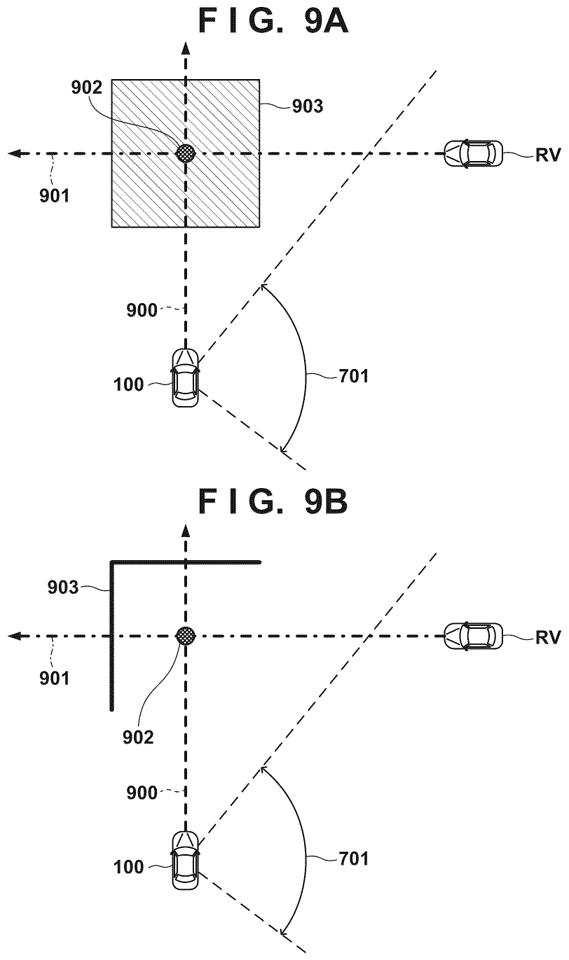

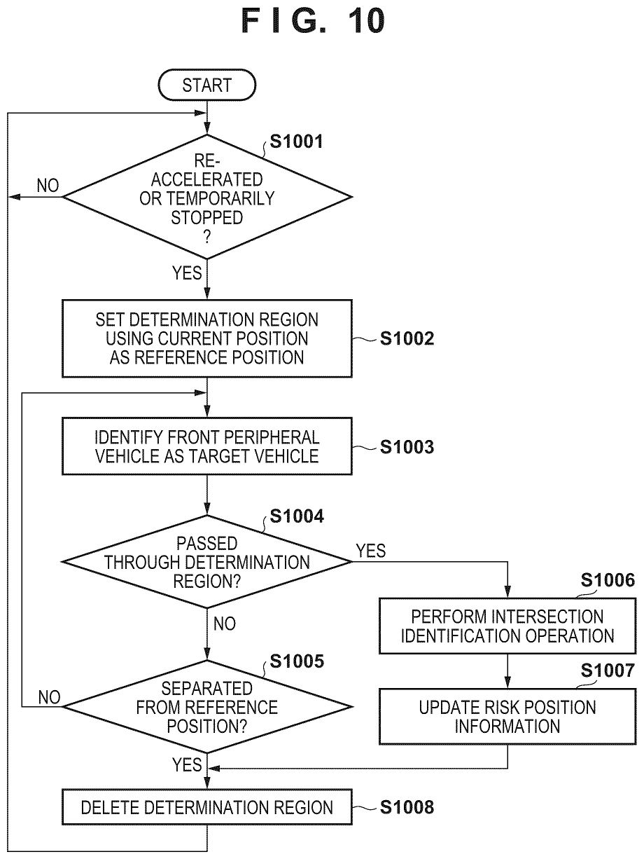

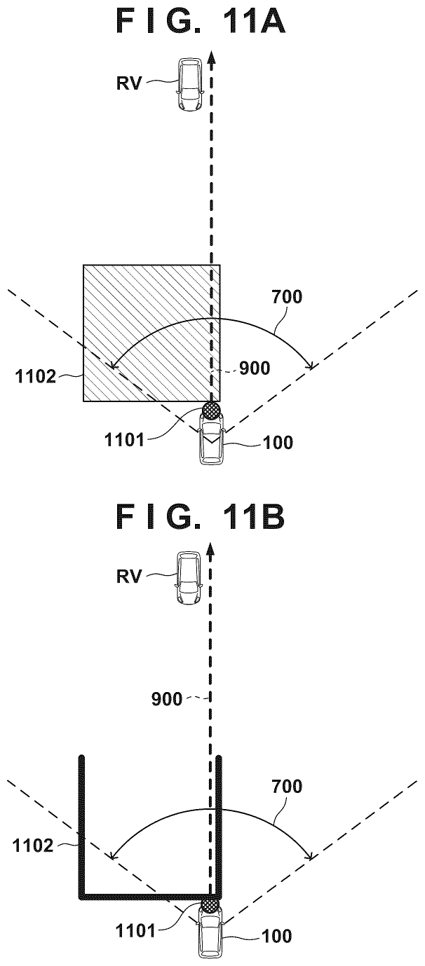

In a case where a peripheral vehicle is included in the range 701, as illustrated in FIG. 3A, the track intersection CPa can be caused by the self-vehicle 100 traveling straight. Therefore, the control device 106 performs the intersection identification operation so that the track intersection CPa can be appropriately identified. This operation will be described later with reference to FIGS. 8 to 9B. On the other hand, in a case where the peripheral vehicle is included in the range 700, as illustrated in FIG. 3B, the track intersection CPb can be caused by the self-vehicle 100 turning left. Therefore, the control device 106 performs the intersection identification operation so that the track intersection CPb can be appropriately identified. This operation will be described later with reference to FIGS. 10 to 11B. The positions of the ranges 700 and 701 with respect to the self-vehicle 100 may be set in advance (for example, at the time of manufacturing the vehicle 100 or at the time of updating the software) and stored in the storage unit 111.

FIG. 8 describes an example of the processing for performing an intersection identification operation in a case where a peripheral vehicle RV (FIG. 9A) exists within the range 701 on the side of the self-vehicle 100. The processing illustrated in the flowchart of FIG. 8 is performed by the processing unit 110 according to the learning program read from the storage unit 111. For example, every time a peripheral vehicle RV is newly registered in step S602 of FIG. 6, the processing in FIG. 8 may be performed for the peripheral vehicle RV. In the processing in FIG. 6, a plurality of other vehicles can be registered as peripheral vehicles. The processing in FIG. 8 is performed for each of the plurality of peripheral vehicles.

In step S801, the processing unit 110 (for example, the identification unit 110c thereof) determines whether or not a peripheral vehicle RV exists within the range 701 on the side of the self-vehicle 100. In a case where it is determined that the peripheral vehicle RV exists within the range 701 on the side of the self-vehicle 100, the processing unit 110 shifts the processing to step S802, and repeats step S801 in other cases. This determination may be made on the basis of the current position of the peripheral vehicle RV included in the latest peripheral vehicle information acquired from the peripheral vehicle RV. In the example illustrated in FIG. 9A, the peripheral vehicle RV exists within the range 701.

In step S802, the processing unit 110 (for example, the identification unit 110c thereof) determines whether or not the predicted course of the self-vehicle 100 and the predicted course of the peripheral vehicle RV intersect. In a case where it is determined that these predicted courses intersect, the processing unit 110 shifts the processing to step S803, and repeats step S802 in other cases. The predicted course may be a half line extending forward from a vehicle. In the example illustrated in FIG. 9A, a predicted course 900 of the self-vehicle 100 and a predicted course 901 of the peripheral vehicle RV intersect. An intersection between the predicted course 900 of the self-vehicle 100 and the predicted course 901 of the peripheral vehicle RV is referred to as a predicted intersection 902. The predicted course 900 of the self-vehicle 100 may be determined on the basis of the self-vehicle information (specifically, the current position and the traveling track). The processing unit 110 may acquire the latest self-vehicle information at this time point. The predicted course 901 of the peripheral vehicle RV may be determined on the basis of the latest peripheral vehicle information (specifically, the current position and the traveling track).

In step S803, the processing unit 110 (for example, the identification unit 110c thereof) sets a determination region using the predicted intersection 902 as a reference position, and stores the reference position and the determination region in the storage unit 111. The determination region may be a region used for determination of performance start of an intersection identification operation to be described later. An example of a determination region 903 set using the predicted intersection 902 as a reference position will be described with reference to FIG. 9A. The determination region 903 may be a square centered on the predicted intersection 902 and including sides parallel to the predicted course 900 of the self-vehicle 100. One side of the square may have a length corresponding to three lanes (for example, about 9 m to 11 m), for example. The determination region 903 is a planar region including the predicted intersection 902. Alternatively, the determination region 903 may have another shape.

In the example of FIG. 9A, the determination region 903 is a planar region. Alternatively, as illustrated in FIG. 9B, the determination region 903 may be a linear region. In the example of FIG. 9B, the determination region 903 is an L-shaped region formed by a side at a position far from the self-vehicle 100 and a side on the opposite lane side (the left side in this example) of a square centered on the predicted intersection 902 and including sides parallel to the predicted course 900 of the self-vehicle 100. The position of the determination region 903 with respect to the reference position may be set in advance (for example, at the time of manufacturing the vehicle 100 or at the time of updating the software) and stored in the storage unit 111.

In step S806, the processing unit 110 (for example, the identification unit 110c thereof) determines whether or not both the peripheral vehicle RV to be subjected to the processing in FIG. 8 and the self-vehicle 100 have passed through the determination region 903. In a case where it is determined that both the peripheral vehicle RV and the self-vehicle 100 have passed through the determination region 903, the processing unit 110 shifts the processing to step S808, and shifts the processing to step S807 in other cases. This determination may be made on the basis of the latest self-vehicle information (specifically, the current position and the traveling track) and the latest peripheral vehicle information (specifically, the current position and the traveling track). Passing through the determination region 903 may mean that the current position of the vehicle does not have a common portion with the determination region 903 after the current position of the vehicle has a common portion with the determination region 903.

In step S808, the processing unit 110 (for example, the identification unit 110c thereof) performs an intersection identification operation. Specifically, the processing unit 110 identifies an intersection (that is, a track intersection) between the traveling track of the self-vehicle 100 and the traveling track of the peripheral vehicle RV after setting the determination region in step S803. The intersection identification operation may be performed on the basis of the latest self-vehicle information and the latest peripheral vehicle information. As described above, the intersection identification operation is performed on the basis of the determination region set using the predicted intersection 902 as a reference position. Therefore, the intersection identification operation can be considered to be performed using the predicted intersection 902 as a reference position. In step S808, the traveling track of the self-vehicle 100 and the traveling track of the peripheral vehicle RV may not have an intersection. In this case, the track intersection is not identified even if the intersection identification operation is performed.

In step S809, the processing unit 110 (for example, the update unit 110d thereof) updates the risk position information 112 on the basis of the track intersection identified by the intersection identification operation in step S808. For example, in a case where the risk position information 112 does not include a risk position near (for example, within 20 m) the track intersection, the processing unit 110 may include the track intersection as a new risk position in the risk position information 112. In a case where the risk position information 112 includes a risk position near the track intersection (for example, within 20 m), the processing unit 110 may correct the risk position on the basis of the track intersection. This correction may be, for example, a weighted average of the risk position and the track intersection. The weight of the risk position may be the number of track intersections used to determine the risk position. When the risk position information 112 is updated, the processing unit 110 also registers information of each column illustrated in FIG. 2. In a case where no track intersection is identified by the intersection identification operation (that is, in a case where the traveling track of the self-vehicle 100 and the traveling track of the peripheral vehicle RV do not intersect with each other), step S809 is skipped (the risk position information 112 is not updated).

In step S810, the processing unit 110 (for example, the identification unit 110c thereof) deletes the reference position and the determination region (the reference position and the determination region stored in step S803), which are no longer necessary due to the end of the intersection identification operation, from the storage unit 111. As a result, the capacity of the storage unit 111 is suppressed from being consumed by unnecessary information.

In a case where it is determined in step S806 that at least one of the peripheral vehicle RV and the self-vehicle 100 has not passed through the determination region 903, step S807 is performed. In step S807, the processing unit 110 (for example, the identification unit 110c thereof) determines whether or not the self-vehicle 100 is separated from the reference position stored in step S803 by a predetermined distance (for example, 30 m) or more. In a case where it is determined that the self-vehicle 100 is separated from the reference position by the predetermined distance or more, the processing unit 110 shifts the processing to step S810, and shifts the processing to step S804 in other cases. In a case where the self-vehicle 100 is separated from the reference position by a predetermined distance or more before both the peripheral vehicle RV and the self-vehicle 100 pass through the determination region 903, for example, there is a possibility that the peripheral vehicle RV or the self-vehicle 100 has changed its course without passing through the determination region 903. Therefore, the processing unit 110 ends the processing without performing the intersection identification operation. Also in this case, in step S810, the processing unit 110 (for example, the identification unit 110c thereof) deletes the unnecessary reference position and determination region from the storage unit 111.

In a case where it is determined in step S807 that the self-vehicle 100 is not separated from the reference position by the predetermined distance or more, step S804 is performed. In step S804, the processing unit 110 (for example, the identification unit 110c thereof) redetermines the predicted intersection 902 and determines whether or not the position of the predicted intersection has changed. In a case where it is determined that the position of the predicted intersection 902 has changed, the processing unit 110 shifts the processing to step S805, and shifts the processing to step S806 in other cases. For example, in a case where a vehicle (self-vehicle 100 or peripheral vehicle RV) changes its position in the lane or changes the lane, the position of the predicted intersection 902 can change. Since the peripheral vehicle information is repeatedly acquired, the processing unit 110 can detect such a change in the position of the predicted intersection 902. Therefore, in step S805, the processing unit 110 (for example, the identification unit 110c thereof) updates the reference position stored in the storage unit 111 on the basis of the newly acquired peripheral vehicle information, and accordingly, updates the determination region stored in the storage unit 111. As a result, the determination in step S806 is performed on the basis of the updated determination region. In addition, the determination in step S807 is performed on the basis of the updated reference position. In step S804, in a case where the predicted intersection 902 cannot be redetermined (for example, in a case where the predicted course 900 of the self-vehicle 100 and the predicted course 901 of the peripheral vehicle RV no longer intersect with each other), the most recently determined reference position and determination region are maintained.

In the method of FIG. 8, the intersection identification operation in step S808 is not performed unless it is determined in step S801 that a peripheral vehicle exists within the range 701, it is determined in step S802 that the predicted course of the peripheral vehicle and the predicted course of the self-vehicle 100 intersect, and it is determined in step S806 that these vehicles have passed through the determination region. As a result, it is possible to suppress the risk position information from being inappropriately updated. In a case where the registration of the peripheral vehicle to be subjected to the processing in FIG. 8 is canceled in step S605 in FIG. 6, the processing unit 110 may stop the processing in FIG. 8.

According to the method of FIG. 8, in a case where a plurality of peripheral vehicles exists within the range 701 on the side of the self-vehicle 100, an individual reference position for each of the plurality of peripheral vehicles is used. Specifically, the method of FIG. 8 is performed individually for each of the plurality of peripheral vehicles. As a result, the predicted intersection between the predicted course of the self-vehicle 100 and the predicted course of the peripheral vehicle is also determined for each of the plurality of peripheral vehicles. As a result, for each of the plurality of peripheral vehicles, an individual determination region is set on the basis of the individual reference position. As a result, it is possible to appropriately estimate the position of an intersection or the like where a plurality of lanes intersects with each other.

FIG. 10 describes an example of processing for performing an intersection identification operation in a case where a peripheral vehicle RV (FIG. 11A) exists within the range 700 in front of the self-vehicle 100. The processing illustrated in the flowchart of FIG. 10 is performed by the processing unit 110 according to the learning program read from the storage unit 111. The processing in FIG. 10 may be started, for example, in response to the ignition of the vehicle 100 being turned on. The processing in FIG. 10 can be repeatedly performed until the ignition of the vehicle 100 is turned off.

In step S1001, the processing unit 110 (for example, the identification unit 110c thereof) determines whether the self-vehicle 100 has accelerated after decelerating to a threshold value or less or the self-vehicle 100 has temporarily stopped. In a case where it is determined that the self-vehicle 100 has accelerated after decelerating to a threshold value or less or the self-vehicle 100 has temporarily stopped, the processing unit 110 shifts the processing to step S1002, and repeats step S1001 in other cases. This determination may be made on the basis of the vehicle speed and the acceleration of the self-vehicle 100 included in the latest self-vehicle information. The threshold value used in step S1001 is a value below the vehicle speed after the vehicle 100 decelerates to turn (for example, left turn or right turn), and may be, for example, 20 km/h. A position where the self-vehicle 100 has accelerated after decelerating to the threshold value or less or a position where the self-vehicle 100 has temporarily stopped is referred to as a turning preparation position 1101 (FIG. 11A). Note that, even when not turning, the self-vehicle 100 can accelerate after decelerating to the threshold value or less or temporarily stop. Even in this case, the processing unit 110 detects the turning preparation position 1101 and performs the processing of and after step S1002.

In step S1002, the processing unit 110 (for example, the identification unit 110c thereof) sets a determination region using the turning preparation position 1101 as a reference position, and stores the reference position and the determination region in the storage unit 111. The determination region may be a region used for determination of performance start of an intersection identification operation to be described later. An example of a determination region 1102 set using the turning preparation position 1101 as a reference position will be described with reference to FIG. 11A. The determination region 1102 may be a square centered on a position on the left front of the turning preparation position 1101 and including sides parallel to the predicted course 900 of the self-vehicle 100. One side of the square may have a length corresponding to three lanes (for example, about 9 m to 11 m), for example. The determination region 1102 is a planar region. Alternatively, the determination region 1102 may have another shape. For example, the determination region 1102 may be a rectangle in which sides parallel to the predicted course 900 of the self-vehicle 100 are long sides. The processing unit 110 sets the determination region 1102 to include the turning preparation position 1101 (that is, the reference position) and to offset to the opposite lane side (the left side in the example of FIG. 11A) with respect to the self-vehicle 100 in the direction orthogonal to the predicted course 900 of the self-vehicle 100. As a result, it is possible to appropriately identify a track intersection caused by the self-vehicle 100 turning left.

In the example of FIG. 11A, the determination region 1102 is a planar region. Alternatively, as illustrated in FIG. 11B, the determination region 1102 may be a linear region. In the example of FIG. 11B, the determination region 1102 is a U-shaped region formed by three sides other than the side at a position far from the self-vehicle 100 of a square centered on the left front position of the turning preparation position 1101 and including sides parallel to the predicted course 900 of the self-vehicle 100. The position of the determination region 1102 with respect to the reference position may be set in advance (for example, at the time of manufacturing the vehicle 100 or at the time of updating the software) and stored in the storage unit 111.

In step S1003, the processing unit 110 (for example, the identification unit 110c thereof) identifies the peripheral vehicle RV existing within the range 700 in front of the self-vehicle 100 as a target vehicle of the subsequent processing. If no peripheral vehicle RV exists within the range 700, no target vehicle is identified. If a plurality of peripheral vehicles RV exists within the range 700, all of the plurality of peripheral vehicles RV are identified as target vehicles. This identification may be made on the basis of the current position of the peripheral vehicle RV included in the latest peripheral vehicle information acquired from the peripheral vehicle RV. In the example illustrated in FIG. 11A, one peripheral vehicle RV exists within the range 700.

In step S1004, the processing unit 110 (for example, the identification unit 110c thereof) determines whether or not the self-vehicle 100 has passed through the determination region 1102. In a case where it is determined that the self-vehicle 100 has passed through the determination region 1102, the processing unit 110 shifts the processing to step S1006, and shifts the processing to step S1005 in other cases. This determination may be made on the basis of the latest self-vehicle information (specifically, the current position and the traveling track). Passing through the determination region 1102 may mean that the current position of the vehicle does not have a common portion with the determination region 1102 after the current position of the vehicle has a common portion with the determination region 1102.

In step S1006, the processing unit 110 (for example, the identification unit 110c thereof) performs the intersection identification operation for each of the vehicles that have passed through the determination region 1102 among all the target vehicles identified in S1003. Specifically, the processing unit 110 identifies an intersection (that is, a track intersection) between the traveling track of the self-vehicle 100 and the traveling track of the target vehicle after setting the determination region in step S1002. The intersection identification operation may be performed on the basis of the latest self-vehicle information and the latest peripheral vehicle information. As described above, the intersection identification operation is performed on the basis of the determination region set using the turning preparation position 1101 as a reference position. Therefore, the intersection identification operation can be considered to be performed using the turning preparation position 1101 as a reference position. In step S1006, the traveling track of the self-vehicle 100 and the traveling track of the peripheral vehicle RV may not have an intersection. In this case, the track intersection is not identified even if the intersection identification operation is performed.

In step S1007, the processing unit 110 (for example, the update unit 110d thereof) updates the risk position information 112 on the basis of the track intersection identified by the intersection identification operation in step S1006. Since the processing in step S1007 may be similar to the processing in step S809, redundant description will be omitted.

In a case where no peripheral vehicle RV identified as the target vehicle in step S1003 exists, or in a case where no target vehicle that has passed through the determination region 1102 exists, steps S1006 and S1007 are skipped.

Since the processing in step S1008 may be similar to the processing in step S810, redundant description will be omitted.

In a case where it is determined in step S1004 that the self-vehicle 100 has not passed through the determination region 1102, step S1005 is performed. In step S1005, the processing unit 110 (for example, the identification unit 110c thereof) determines whether or not the self-vehicle 100 is separated from the reference position (that is, the turning preparation position 1101) stored in step S1002 by a predetermined distance (for example, 30 m) or more. In a case where it is determined that the self-vehicle 100 is separated from the reference position by the predetermined distance or more, the processing unit 110 shifts the processing to step S1008, and shifts the processing to step S1003 in other cases. In a case where the self-vehicle 100 is separated from the reference position by the predetermined distance or more before the self-vehicle 100 passes through the determination region 1102, for example, there is a possibility that the self-vehicle 100 has changed its course without passing through the determination region 1102. Therefore, the processing unit 110 ends the processing without performing the intersection identification operation. Also in this case, in step S1008, the processing unit 110 (for example, the identification unit 110c thereof) deletes the unnecessary reference position and determination region from the storage unit 111.

In a case where it is determined in step S1005 that the self-vehicle 100 is not separated from the reference position by the predetermined distance or more, step S1003 is performed again. In step S1003, the processing unit 110 (for example, the identification unit 110c thereof) identifies a peripheral vehicle RV newly included within the range 700 as a target vehicle of the subsequent processing. Even in a case where the new peripheral vehicle exists within the range 700, the processing unit 110 does not perform step S1002 (that is, a new determination region 1102 is not set) until a determination region 1102 is set in step S1002 and the determination region 1102 is deleted in step S1008.

In the method of FIG. 10, unless it is determined in step S1001 that the self-vehicle 100 has re-accelerated or temporarily stopped, and it is determined in step S1004 that the peripheral vehicle RV and the self-vehicle 100 existing within the range 700 have passed through the determination region, the intersection identification operation in step S1006 is not performed. As a result, it is possible to suppress the risk position information from being inappropriately updated.

According to the method of FIG. 10, in a case where a plurality of peripheral vehicles exists within the range 700 in front of the self-vehicle 100, the reference position common to the plurality of peripheral vehicles (that is, the turning preparation position 1101) is used. As a result, for each of the plurality of peripheral vehicles, a common determination region is set on the basis of the common reference position. As a result, it is possible to appropriately estimate the position of the intersection when the self-vehicle 100 turns to the opposite lane side (for example, when turning left).

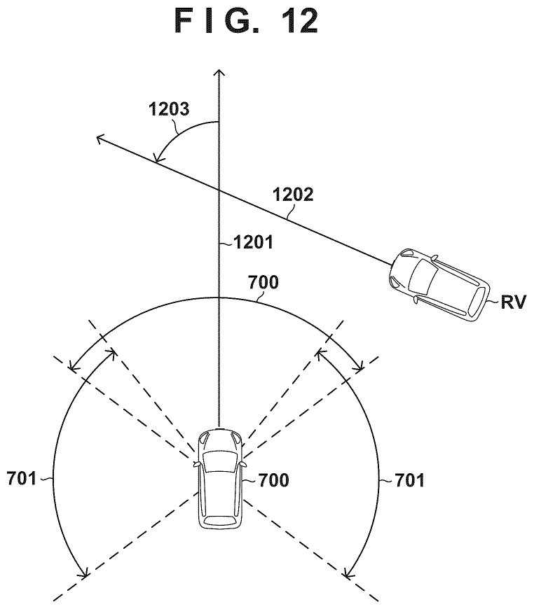

In the driving assistance method described above, on the basis of the peripheral vehicle RV being located within the range 700 or 701 of FIG. 7, the peripheral vehicle RV is set as a learning target of the risk position. On the basis of other information, the processing unit 110 may determine whether or not the peripheral vehicle RV is set as a learning target of the risk position. An example of a method of determining the peripheral vehicle RV to be set as a learning target of the risk position will be described with reference to FIG. 12.

Further, on the basis of a rotation angle 1203 of a course vector 1202 of the peripheral vehicle RV with respect to a course vector 1201 of the self-vehicle 100, the processing unit 110 may determine whether or not the peripheral vehicle RV is set as a learning target of the risk position. The course vector 1201 may also be a unit vector facing the traveling direction of a vehicle. For the sake of explanation, the rotation angle 1203 is set such that the clockwise direction is positive and the counterclockwise direction is negative. The processing unit 110 can determine the approaching direction of the peripheral vehicle RV on the basis of the direction of the peripheral vehicle RV with respect to the self-vehicle 100 and the rotation angle 1203 of the course vector 1202 of the peripheral vehicle RV with respect to the course vector 1201 of the self-vehicle 100.

Even if the peripheral vehicle RV is included in the range 700 in front of the self-vehicle 100, it is considered that there is no collision possibility between the self-vehicle 100 and the peripheral vehicle RV in a case where the peripheral vehicle RV is traveling in the same direction as the self-vehicle 100 or traveling in the right direction or the left direction with respect to the self-vehicle 100. Therefore, in a case where the peripheral vehicle RV is within the range 700 in front of the self-vehicle 100 and the rotation angle 1203 is included in a predetermined range (for example, 160° to 200°), the processing unit 110 may set the peripheral vehicle RV as a learning target of the risk position in the processing in FIG. 4.

Even if the peripheral vehicle RV is included in the range 701 on the right side of the self-vehicle 100, it is considered that there is no collision possibility between the self-vehicle 100 and the peripheral vehicle RV in a case where the peripheral vehicle RV is traveling in the same direction as or opposite direction to the self-vehicle 100 or traveling in the right direction with respect to the self-vehicle 100. Therefore, in a case where the peripheral vehicle RV is within the range 701 on the right side of the self-vehicle 100 and the rotation angle 1203 is included in a predetermined range (for example, −110° to −70°), the processing unit 110 may set the peripheral vehicle RV as a learning target of the risk position in the processing in FIG. 4.

Even if the peripheral vehicle RV is included in the range 701 on the left side of the self-vehicle 100, it is considered that there is no collision possibility between the self-vehicle 100 and the peripheral vehicle RV in a case where the peripheral vehicle RV is traveling in the same direction as or opposite direction to the self-vehicle 100 or traveling in the left direction with respect to the self-vehicle 100. Therefore, in a case where the peripheral vehicle RV is within the range 701 on the left side of the self-vehicle 100 and the rotation angle 1203 is included in a predetermined range (for example, 70° to 110°), the processing unit 110 may set the peripheral vehicle RV as a learning target of the risk position in the processing in FIG. 4.

According to the above-described embodiment, since an appropriate intersection identification operation is performed according to the position of a peripheral vehicle, risk position information can be accurately determined. As a result, driving assistance for the self-vehicle 100 can be appropriately performed.

### Summary of Embodiments

[Item 1] A driving assistance device (106) comprising:
a storage unit (111) configured to store risk position information (112) indicating a position where there is a possibility that a self-vehicle (100) mounted with the driving assistance device collides with another vehicle (RV);
an assistance unit (110b) configured to perform driving assistance for the self-vehicle based on the risk position information;
an acquisition unit (111a) configured to acquire, from a peripheral vehicle existing around the self-vehicle, peripheral vehicle information indicating a vehicle speed, a position, and a traveling track of the peripheral vehicle by vehicle-to-vehicle communication;
an identification unit (110c) configured to perform an intersection identification operation of identifying an intersection (CPa, CPb) between a traveling track of the self-vehicle and a traveling track of the peripheral vehicle; and
an update unit (110d) configured to update the risk position information based on the intersection identified by the intersection identification operation, wherein
the identification unit:
   performs the intersection identification operation using, as a first reference position (1101), a position where the self-vehicle accelerates after decelerating to a threshold value or less or a position where the self-vehicle temporarily stops in a case where the peripheral vehicle exists within a first range (700) in front of the self-vehicle; and
   performs the intersection identification operation using, as a second reference position (902), an intersection between a predicted course (900) of the self-vehicle and a predicted course (901) of the peripheral vehicle in a case where the peripheral vehicle exists within a second range (701) on a side of the self-vehicle.

According to this item, the risk position information can be appropriately updated, and as a result, the driving assistance can be appropriately provided.

[Item 2] The driving assistance device according to Item 1, wherein
the identification unit:
   uses the first reference position common to a plurality of peripheral vehicles in a case where the plurality of peripheral vehicles exists within the first range; and
   uses a respective second reference position for each of a plurality of peripheral vehicles in a case where the plurality of peripheral vehicles exists within the second range.

According to this item, the risk position information can be more appropriately updated.

[Item 3] The driving assistance device according to Item 1 or 2, wherein
the identification unit:
   sets a first determination region (1102) with respect to the first reference position in a case where the peripheral vehicle exists within the first range, and performs the intersection identification operation in a case where both the peripheral vehicle and the self-vehicle pass through the first determination region; and
   sets a second determination region (903) with respect to the second reference position in a case where the peripheral vehicle exists within the second range, and performs the intersection identification operation in a case where both the peripheral vehicle and the self-vehicle pass through the second determination region.

According to this item, the risk position information can be more appropriately updated.

[Item 4] The driving assistance device according to Item 3, wherein
the identification unit sets the first determination region to include the first reference position and to offset to an opposite lane side with respect to the self-vehicle in a direction orthogonal to a predicted course of the self-vehicle.

According to this item, the risk position information can be more appropriately updated.

[Item 5] The driving assistance device according to Item 3 or 4, wherein
the identification unit sets the second determination region to include the second reference position.

According to this item, the risk position information can be more appropriately updated.

[Item 6] The driving assistance device according to any one of Items 3-5, wherein
the acquisition unit repeatedly acquires the peripheral vehicle information from the peripheral vehicle, and
the identification unit:
   does not newly set the first determination region in a case where a new peripheral vehicle different from the peripheral vehicle exists within the first range and the first determination region is set; and
   updates the second reference position based on the newly acquired peripheral vehicle information and accordingly, updates the second determination region in a case where the peripheral vehicle exists within the second range.

According to this item, the risk position information can be more appropriately updated.

[Item 7] The driving assistance device according to any one of Items 3-6, wherein
the identification unit:
   deletes the first determination region in a case where the intersection identification operation is ended after the first determination region is set or in a case where the self-vehicle is separated from the first reference position by a predetermined distance or more; and
   deletes the second determination region in a case where the intersection identification operation is ended after the second determination region is set or in a case where the self-vehicle is separated from the updated second reference position by a predetermined distance or more.

According to this item, the capacity of the storage unit can be appropriately used.

[Item 8] A method of assisting driving, the method performed by a self-vehicle (100), wherein the self-vehicle includes a storage unit (111) configured to store risk position information (112) indicating a position where there is a possibility that the self-vehicle collides with another vehicle (RV), the method comprising:
performing (S409) driving assistance for the self-vehicle based on the risk position information;
acquiring (S603), from a peripheral vehicle (RV) existing around the self-vehicle, peripheral vehicle information indicating a vehicle speed, a position, and a traveling track of the peripheral vehicle by vehicle-to-vehicle communication;
performing (S808, S1006) an intersection identification operation of identifying an intersection (CPa, CPb) between a traveling track of the self-vehicle and a traveling track of the peripheral vehicle; and
updating (S809, S1007) the risk position information based on the intersection identified by the intersection identification operation, wherein
the identification operation includes:
   performing the intersection identification operation using, as a first reference position (1101), a position where the self-vehicle accelerates after decelerating to a threshold value or less or a position where the self-vehicle temporarily stops in a case where the peripheral vehicle exists within a first range (700) in front of the self-vehicle; and
   performing the intersection identification operation using, as a second reference position (902), an intersection between a predicted course (901) of the self-vehicle and a predicted course (902) of the peripheral vehicle in a case where the peripheral vehicle exists within a second range (701) on a side of the self-vehicle.

According to this item, the risk position information can be appropriately updated, and as a result, the driving assistance can be appropriately provided.

[Item 9] A non-transitory storage medium configured to store a program for making computer mounted on a self-vehicle (100) including a storage unit (111) configured to store risk position information (112) indicating a position where there is a possibility that the self-vehicle collides with another vehicle (RV), perform:
performing (S409) driving assistance for the self-vehicle based on the risk position information;
acquiring (S603), from a peripheral vehicle (RV) existing around the self-vehicle, peripheral vehicle information indicating a vehicle speed, a position, and a traveling track of the peripheral vehicle by vehicle-to-vehicle communication;
performing (S808, S1006) an intersection identification operation of identifying an intersection (CPa, CPb) between a traveling track of the self-vehicle and a traveling track of the peripheral vehicle; and
updating (S809, S1007) the risk position information based on the intersection identified by the intersection identification operation, wherein
the identification operation includes:
   performing the intersection identification operation using, as a first reference position (1101), a position where the self-vehicle accelerates after decelerating to a threshold value or less or a position where the self-vehicle temporarily stops in a case where the peripheral vehicle exists within a first range (700) in front of the self-vehicle; and
   performing the intersection identification operation using, as a second reference position (902), an intersection between a predicted course (900) of the self-vehicle and a predicted course (901) of the peripheral vehicle in a case where the peripheral vehicle exists within a second range (701) on a side of the self-vehicle.

According to this item, the risk position information can be appropriately updated, and as a result, the driving assistance can be appropriately provided.

The invention is not limited to the foregoing embodiments, and various variations/changes are possible within the spirit of the invention.

What is claimed is:

1. A driving assistance device comprising:
a storage unit configured to store risk position information indicating a position where there is a possibility that a self-vehicle mounted with the driving assistance device collides with another vehicle;
an assistance unit configured to perform driving assistance for the self-vehicle based on the risk position information;
an acquisition unit configured to acquire, from a peripheral vehicle existing around the self-vehicle, peripheral vehicle information indicating a vehicle speed, a position, and a traveling track of the peripheral vehicle by vehicle-to-vehicle communication;
an identification unit configured to perform an intersection identification operation of identifying an intersection between a traveling track of the self-vehicle and a traveling track of the peripheral vehicle; and
an update unit configured to update the risk position information based on the intersection identified by the intersection identification operation, wherein
the identification unit:
performs the intersection identification operation using, as a first reference position, a position where the self-vehicle accelerates after decelerating to a threshold value or less or a position where the self-vehicle temporarily stops in a case where the peripheral vehicle exists within a first range in front of the self-vehicle; and
performs the intersection identification operation using, as a second reference position, an intersection between a predicted course of the self-vehicle and a predicted course of the peripheral vehicle in a case where the peripheral vehicle exists within a second range on a side of the self-vehicle.

2. The driving assistance device according to claim 1, wherein
the identification unit:
uses the first reference position common to a plurality of peripheral vehicles in a case where the plurality of peripheral vehicles exists within the first range; and
uses a respective second reference position for each of a plurality of peripheral vehicles in a case where the plurality of peripheral vehicles exists within the second range.

3. The driving assistance device according to claim 1, wherein
the identification unit:
sets a first determination region with respect to the first reference position in a case where the peripheral vehicle exists within the first range, and performs the intersection identification operation in a case where both the peripheral vehicle and the self-vehicle pass through the first determination region; and
sets a second determination region with respect to the second reference position in a case where the peripheral vehicle exists within the second range, and performs the intersection identification operation in a case where both the peripheral vehicle and the self-vehicle pass through the second determination region.

4. The driving assistance device according to claim 3, wherein
the identification unit sets the first determination region to include the first reference position and to offset to an opposite lane side with respect to the self-vehicle in a direction orthogonal to a predicted course of the self-vehicle.

5. The driving assistance device according to claim 3, wherein
the identification unit sets the second determination region to include the second reference position.

6. The driving assistance device according to claim 3, wherein
the acquisition unit repeatedly acquires the peripheral vehicle information from the peripheral vehicle, and
the identification unit:
does not newly set the first determination region in a case where a new peripheral vehicle different from the peripheral vehicle exists within the first range and the first determination region is set; and
updates the second reference position based on the newly acquired peripheral vehicle information and accordingly, updates the second determination region in a case where the peripheral vehicle exists within the second range.

7. The driving assistance device according to claim 3, wherein
the identification unit:
deletes the first determination region in a case where the intersection identification operation is ended after the first determination region is set or in a case where the self-vehicle is separated from the first reference position by a predetermined distance or more; and
deletes the second determination region in a case where the intersection identification operation is ended after the second determination region is set or in a case where the self-vehicle is separated from the updated second reference position by a predetermined distance or more.

8. A method of assisting driving, the method performed by a self-vehicle, wherein the self-vehicle includes a storage unit configured to store risk position information indicating a position where there is a possibility that the self-vehicle collides with another vehicle, the method comprising:
performing driving assistance for the self-vehicle based on the risk position information;
acquiring, from a peripheral vehicle existing around the self-vehicle, peripheral vehicle information indicating a vehicle speed, a position, and a traveling track of the peripheral vehicle by vehicle-to-vehicle communication;
performing an intersection identification operation of identifying an intersection between a traveling track of the self-vehicle and a traveling track of the peripheral vehicle; and
updating the risk position information based on the intersection identified by the intersection identification operation, wherein
the identification operation includes:
performing the intersection identification operation using, as a first reference position, a position where the self-vehicle accelerates after decelerating to a threshold value or less or a position where the self-vehicle temporarily stops in a case where the peripheral vehicle exists within a first range in front of the self-vehicle; and
performing the intersection identification operation using, as a second reference position, an intersection between a predicted course of the self-vehicle and a predicted course of the peripheral vehicle in a case where the peripheral vehicle exists within a second range on a side of the self-vehicle.

9. A non-transitory storage medium configured to store a program for making computer mounted on a self-vehicle including a storage unit configured to store risk position information indicating a position where there is a possibility that the self-vehicle collides with another vehicle, perform:
performing driving assistance for the self-vehicle based on the risk position information;
acquiring, from a peripheral vehicle existing around the self-vehicle, peripheral vehicle information indicating a vehicle speed, a position, and a traveling track of the peripheral vehicle by vehicle-to-vehicle communication;
performing an intersection identification operation of identifying an intersection between a traveling track of the self-vehicle and a traveling track of the peripheral vehicle; and
updating the risk position information based on the intersection identified by the intersection identification operation, wherein
the identification operation includes:
performing the intersection identification operation using, as a first reference position, a position where the self-vehicle accelerates after decelerating to a threshold value or less or a position where the self-vehicle temporarily stops in a case where the peripheral vehicle exists within a first range in front of the self-vehicle; and
performing the intersection identification operation using, as a second reference position, an intersection between a predicted course of the self-vehicle and a predicted course of the peripheral vehicle in a case where the peripheral vehicle exists within a second range on a side of the self-vehicle.
